(19) United States
(12) Patent Application Publication
(10) Pub. No.: US 2005/0012279 A1
(43) Pub. Date: Jan. 20, 2005

(54) Gasket having an inner edge with coined angles and method of manufacture

(76) Inventor: James W. Hodges, Palmersville, TN (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/619,773

(22) Filed: Jul. 15, 2003

(51) Int. Cl. F16J 15/46

(52) U.S. Cl. 277/628

(57) ABSTRACT

A gasket having a metal base sheet wherein the sheet includes apertures. The apertures are bounded by an edge of the sheet. The edge includes coined angles. An elastomeric material is disposed on the coined angles and the edge to form a sealing bead. The coined angles increase the surface area of the base sheet exposed to the elastomeric material to form a stronger bond between the base sheet and the elastomeric material. A texture may be applied to the coined angles to further increase the surface area of the base sheet exposed to the elastomeric material. This abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD

The present invention relates to a gasket for an internal combustion engine, and more particularly to a gasket having an inner edge with coined angles thereby increasing the surface area of the gasket exposed to an elastomeric material.

### BACKGROUND OF THE INVENTION

Planar-style gaskets employed in the automotive arena, including air intake manifolds, have traditionally been formed of composite body materials having sealing beads. The beads are generally positioned along a peripheral edge of the gasket body. When the gasket is compressed between two joining surfaces such as an engine head and engine block, the beads also compress and form a seal between the joining surfaces. The seal prevents the transmission of fluid or gases and with the example of the air intake manifold gasket, the seal prevents the transfer of an air/fuel mixture. A traditional material used to form the sealing beads is an elastomeric material such as silicone rubber. Silicone rubber has achieved a perception in the automotive industry of superior sealing results and is relatively inexpensive when compared to other alternative materials.

Conventional gaskets have a metal base sheet with an edge that surrounds an aperture. The elastomeric material is bonded to the edge to form the sealing bead. In an attempt to reduce the overall weight of an engine, a thin metal base sheet is greatly desired. However, a thin base sheet has a reduced surface area of the inner edge that is exposed to the elastomeric material. Accordingly, a poor bond results between the base sheet and the elastomeric material and seal failure occurs from the rigorous pressure and high temperature demands of modern engines. The sealing bead of elastomeric material is compressed under these conditions and bursts or tears, thereby leaking fluid and gases. Further, the gasket generally fails to meet emission standards.

A gasket having a thin metal base sheet and a strong bond between the base sheet and the elastomeric sealing bead is needed particularly with air intake manifold applications. The gasket should have improved sealing capabilities and a convenient method of manufacture.

### BRIEF SUMMARY OF THE INVENTION

The inventor of the present invention has recognized these and other problems associated with conventional gaskets described above. To this end, the inventor has developed a gasket that incorporates a thin metal base sheet, but also has a strong bond between the base sheet and the elastomeric material of the sealing bead.

Specifically, the invention comprises a gasket having a base sheet of substantially contiguous metal material and having at least one aperture. The aperture is bounded by an edge of the base sheet. Further, one or more coined angles are formed at the edge of the base sheet and an elastomeric material is disposed on the coined angles and the edge. The coined angles increase a surface area of the base sheet exposed to the elastomeric material, thereby increasing the bonding strength between the base sheet and the elastomeric material.

Further, the invention also comprises a convenient method of manufacturing the gasket. First, one or more coined angles are formed at the edge of the base sheet of substantially contiguous metal material. Next, the method includes disposing the elastomeric material on the one or more coined angles. Again, the coined angles increase the surface area of the base sheet exposed to the elastomeric material and therefore increase the bonding strength between the base sheet and the elastomeric material.

### BRIEF DESCRIPTION OF THE DRAWINGS

In the drawings:

FIG. 1 is a top view of a gasket having beads for use with an air intake manifold in accordance with the present invention; and

FIG. 2 is a cross-sectional view along lines 2-2 in FIG. 1 of the gasket having coined angles at an inner edge for use with an air intake manifold.

### DETAILED DESCRIPTION OF THE INVENTION

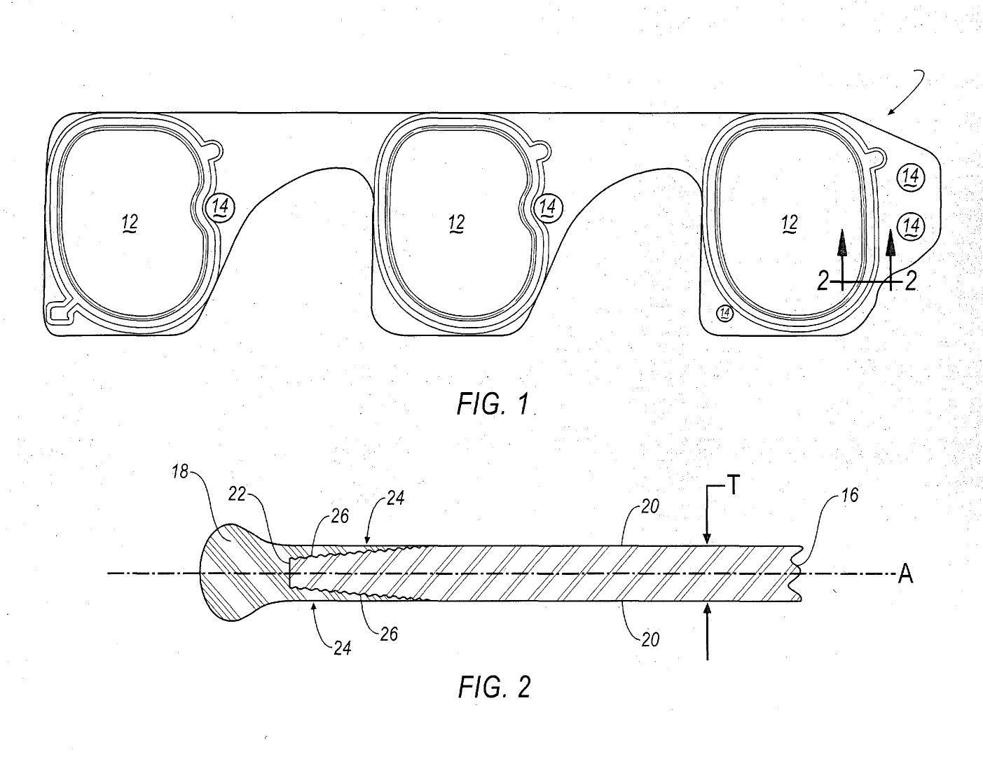

Referring to FIG. 1, a gasket is generally shown at 10. The gasket 10 is preferably an air intake manifold gasket and includes at least one aperture 12. In the drawing, the gasket 10 includes three apertures 12, however, the present invention many include any number of apertures 12. Further, the gasket 10 also includes a plurality of holes 14, such as bolt holes and water holes. Again, the gasket 10 may include any number of holes 14 as necessary to accommodate a specific engine configuration.

As best seen in the cross-sectional view of FIG. 2, the gasket 10 is a composite gasket 10 comprised of a base sheet 16 and a sealing bead 18. The base sheet 16 is preferably a substantially contiguous metal sheet 16 that includes generally planar surfaces 20. Each aperture 12 and hole 14 of the gasket 10 extends through the metal base sheet 16. Further, each aperture 12 is bounded by an edge 22 of the base sheet 16. The edge 22 is generally orthogonal to the generally planar surfaces 20 of the metal base sheet 16. Additionally, the base sheet 16 is substantially thin as compared to conventional air intake manifold gaskets and preferably has a thickness, T, of approximately 1.0 mm.

One aspect of the invention is that the gasket 10 further includes one or more coined angles 24 formed at the edge 22 of the metal base sheet 16. As shown in the drawings, the base sheet 16 includes two coined angles 24; however, the invention may only need one coined angle 24. The coined angles 24 extend radially inwardly from the edge 22 of the base sheet 16 surrounding the apertures 12 to the planar surfaces 20 of the base sheet 16. Further, the coined angles 24 are integrally joined to the base sheet 16. The angles 24 are formed between the edge 22 and the planar surfaces 20 by a manufacturing technique commonly known as coining. This technique is well known to one skilled in the art. Additionally, as shown in the drawings, the coined angles 24 may extend between the edge 22 and the planar surfaces 20 at generally equal symmetric angles of approximately 10 degrees about an axis, A. However, the angles 24 may extend at any angle with respect to the axis, A, and do not necessarily need to be equal to each other.

Furthermore, elastomeric material is disposed on the coined angles 24 and the edge 22 to form the sealing bead 18. The elastomeric material is of a type well-known in the art, such as silicone rubber, or the like. The elastomeric material flows around the edge 22 and over the coined angles 24. When the gasket 10 is compressed between two joining surfaces, such as an engine head (not shown) and an engine block (not shown), the silicone rubber sealing bead 18 is also compressed and forms a seal between the joining surfaces.

The coined angles 24 of the present invention increase the surface area of the base sheet 16 exposed to the elastomeric material of the sealing bead 16. In conventional gaskets, the elastomeric material was only disposed at the edge 22 of the gasket 10. Due to demands for lighter and less expensive engines, the base sheet 16 of the gasket 10 is preferably much thinner than in conventional gaskets. Accordingly, the edge 22 in contact with the elastomeric material is also reduced and a weak bond results. A weak bond between the base sheet 16 and the elastomeric material of the sealing bead 18 may result in failure of the sealing bead 18 when under the pressure and temperature demands of modern engines. Accordingly, the coined angles 24 increase the surface area of the base sheet 16 exposed to the elastomeric material. As a result of the increased surface area, the bonding strength between the base sheet 16 and the elastomeric material of the sealing bead 18 is thereby also increased.

An additional feature of the invention includes applying a texture 26 to the coined angles 24. A texture 26, such as a wavy outer surface as shown in the drawing, further increases the surface area of the base sheet 16 exposed to the elastomeric material of the sealing bead 18. The texture 26 may be a material added to the outer surface of the coined angles 24 or a manufacturing technique may be used to remove metal from the outer surface of the coined angles 24. As described above, the texture 26 also increases the bonding strength between the base sheet 16 and the elastomeric material of the sealing bead 18 and thereby reduces the likelihood of sealing bead 18 failures.

Finally, the gasket 10 of the present invention has a convenient method of manufacture. First, the angles 24 are formed at the edge 22 of the base sheet 16, preferably by the commonly known manufacturing technique of coining. However, the angles 24 may be formed by any technique known in the art to shape metal. During formation of the coined angles 24, the coined angles 24 may have a texture applied by either adding a material to or removing metal from the surface of the coined angles 24. Next, elastomeric material is disposed on the coined angles 24 and the edge 22. The elastomeric material surrounds the edge 22 and covers the coined angles 24 to form the sealing bead 18. Again, the coined angles 24 increase the surface area of the base sheet 16 exposed to the elastomeric material, thereby increasing the boding strength between the base sheet 16 and the elastomeric material.

While the invention has been specifically described in connection with certain specific embodiments thereof, it is to be understood that this is by way of illustration and not of limitation, and the scope of the appended claims should be construed as broadly as the prior art will permit.

1. A gasket comprising:
a base sheet of substantially contiguous metal material having at least one aperture bounded by an edge of said base sheet;
one or more coined angles formed at said edge of said base sheet;
an elastomeric material disposed on said one or more coined angles and said edge of said base sheet; and
wherein said one or more coined angles increase a surface area of said base sheet exposed to said elastomeric material, thereby increasing bonding strength between said base sheet and said elastomeric material.

2. A gasket according to claim 1, wherein said one or more coined angles includes a texture to further increase the bonding strength between said base sheet and said elastomeric material.

3. A gasket according to claim 1, wherein said elastomeric material disposed on said one or more coined angles forms a sealing bead.

4. A gasket according to claim 1, wherein said base sheet is substantially thin.

5. A gasket according to claim 4, wherein said base sheet has a thickness of approximately 1.0 mm.

6. A gasket according to claim 1, wherein said coined angles extend radially inwardly from said edge and are integrally joined to said base sheet.

7. A gasket according to claim 1, wherein said base sheet is generally planar.

8. A gasket according to claim 1, wherein said elastomeric material comprises silicone rubber.

9. A gasket according to claim 1, wherein said coined angles are generally symmetric about an axis, A, of said base sheet.

10. A method of manufacturing a gasket comprising the steps of:
forming one or more coined angles at an edge of a base sheet of substantially contiguous metal material;
disposing an elastomeric material on the one or more coined angles and on the edge of the base sheet;
whereby the one or more coined angles increase a surface area of the base sheet exposed to the elastomeric material, thereby increasing bonding strength between the base sheet and the elastomeric material.

11. A method of manufacturing a gasket according to claim 10, further comprising the step of applying a texture to an outer surface of the one or more coined angles.
